(19) United States
(12) Patent Application Publication
(10) Pub. No.: US 2008/0013908 A1
(43) Pub. Date: Jan. 17, 2008

(54) TOTAL INTERNAL REFLECTION PRISM MOUNT

(75) Inventor: Joel Z. Howard, Amelia, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/618,151

(22) Filed: Dec. 29, 2006

Related U.S. Application Data
(60) Provisional application No. 60/755,815, filed on Jan. 3, 2006.

(51) Int. Cl. G02B 6/00; G02B 6/36

(52) U.S. Cl. 385/134; 362/581

(57) ABSTRACT

One aspect of the invention relates to an optical device that includes an elongate optical element, first and second frame member, and a plurality of contact supports. The optical element includes total internal reflection properties along a length of the optical element. The first and second frame members are positioned at opposing ends of the optical element. The plurality of contact supports are mounted between the optical element and the first and second support frames. The contact supports each provide a point contact or a line contact with the optical element to hold the optical element in the XY plane.

### CROSS-REFERENCE TO RELATED APPLICATION

This application claims the benefit of U.S. Provisional Patent Application No. 60/755,815, filed Jan. 3, 2006, incorporated by reference herein in its entirety.

### BACKGROUND

The invention relates to optical systems and more particularly to optical systems that require mounting of prism rods in the optical system.

A structure with total internal reflection (TIR) capabilities functions based on difference in refractive index between the TIR object and its interface with air (or another adjacent material). When the TIR object is contacted by another solid object, the engaging object typically acts as a light sink at the point of contact wherein light internally reflected within the TIR structure escapes at the point of contact. The more light that escapes from a TIR object, the less effective and efficient the TIR object is for its intended purpose of maintaining complete and total internal reflection of the light that enters the object.

### SUMMARY

The invention generally relates to optical systems that use optical elements such as total internal reflection (TIR) rods, and related aspects of mounting the rods in the optical system. An important aspect of the invention relates to mounting of the TIR rods with minimum contact. By minimizing contact with the rod, negative effects on the internal reflection of light within the rod can also be minimized.

One aspect of the invention relates to an optical device that includes an elongate optical element, first and second frame member, and a plurality of contact supports. The optical element includes total internal reflection properties along a length of the optical element. The first and second frame members are positioned at opposing ends of the optical element. The plurality of contact supports are mounted between the optical element and the first and second support frames. The contact supports each provide a point contact or a line contact with the optical element to hold the optical element in an XY plane.

### BRIEF DESCRIPTION OF THE DRAWINGS

The invention may be more completely understood in consideration of the following detailed description of the various embodiments of the invention in connection with the accompanying drawings, in which:

FIG. 1 is a top perspective view of an example optical device according to principles of the present invention;

FIG. 2 is an exploded perspective view of a light generating subassembly of the optical device shown in FIG. 1;

FIG. 3 is a perspective view of a prism assembly of the light generating subassembly shown in FIG. 2;

FIG. 4 is an exploded perspective view of the prism assembly shown in FIG. 3;

FIG. 5 is a perspective view of a portion of the prism assembly shown in FIG. 3;

FIG. 6 is a close up perspective view of the portion of the prism assembly shown in FIG. 5;

FIG. 7 is an end view of a portion of another prism assembly embodiment according to principles of the present invention; and

FIG. 8 is a schematic diagram illustrating an example optical display system in accordance with one aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems that use optical elements for the purpose of providing an illumination light source. The optical elements can include total internal reflection (TIR) properties to enhance the intensity and directability of the resulting beam of light directed out of the optical element. The invention is believed to be particularly useful for image projection systems that incorporate TIR optical elements for improving the intensity of a light source for different light colors generated by the optical system. While the invention may be useful in any application where a TIR optical element is used, it is described below particularly as used in projection systems. The scope of the invention is not intended to be limited to only projection systems. Some specific systems wherein the optical devices of the invention are used include televisions, rear projection display devices, front projection display devices, heads-up displays, head-mounted displays, and wearable displays.

A TIR optical element is typically an optical component that collects lights from one or more light sources (e.g., light emitting diodes (LEDs) and directs the collected light out of one of the ends of the component for use in providing illumination, e.g., for generating an image. One aspect of the invention relates to a configuration and related method for supporting and positioning a prismatic optical element having TIR properties. To prevent loss of light through contact areas on the optical element where the optical element is supported, supporting elements that contact the optical element provide minimized contact. In theory, the contact area resulting from engagement of the supporting element with the optical element is a point contact or a line contact that provides minimal loss of light through the TIR surface of the optical element. A point contact can result from a spherical or convex structure or a pointed object. A line contact can result from, e.g., a razor blade or a cylindrical structure, or from contact at an edge at the intersection of two faces of the TIR structure. Spherical and cylindrical objects can provide advantages of a theoretical point or line contact without imposing significant stress points on the optical element that could result in damage to the optical element.

Arranging a plurality of supporting elements in engagement with the optical element can provide accurate positioning of the optical element. Some of the supporting elements can be fixed relative to the optical element to establish a mounting plane while other supporting elements can be movable or adjustable relative to the optical element. The adjustability of the adjustable supporting elements can allow for optic dimensional variation adjustments of the optical element. The adjustable supporting elements can also include an elastic portion that permits movement of the adjustable supporting elements upon expansion and contraction of the optical element caused by temperature changes during operation of the optical system. If no adjustability of the supporting elements were provided, temperature dependent stress could occur in the optical element resulting in damage to the optical element or less than optimum performance.

The use of spherical, cylindrical and similar structures for supporting optical elements with minimum contact area can provide advantages of ease of manufacturing as compared to other types of structures such as pointed structures and sharp edges that also provide minimum contact area with the optical element.

Example Optical Device

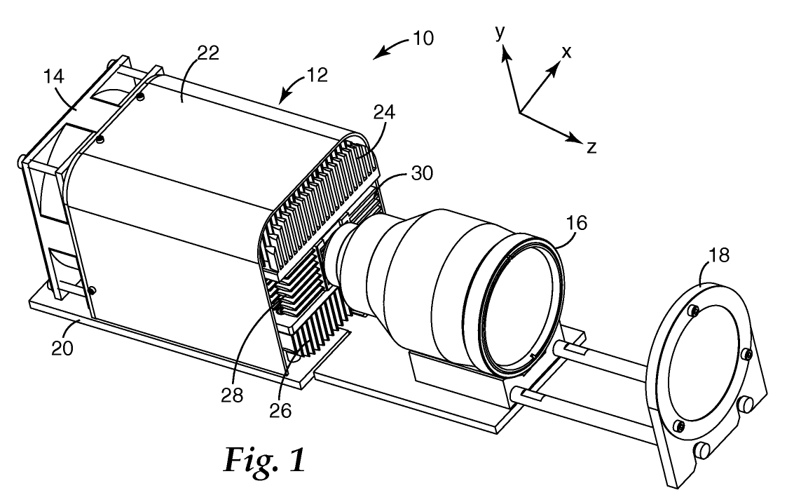

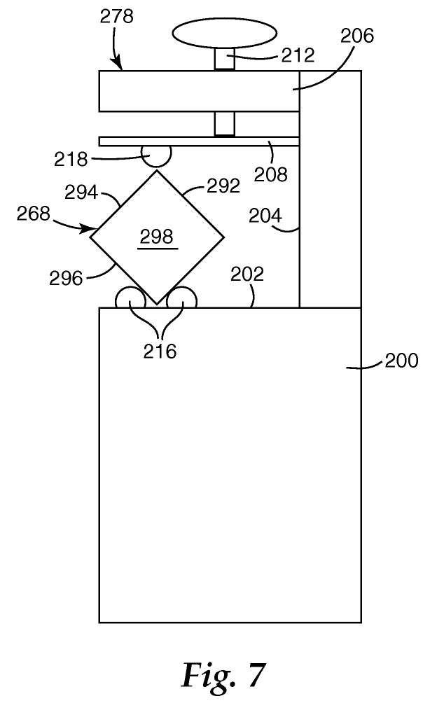

An optical device including an example support structure for supporting an optical element is shown and described with reference to FIGS. 1-6. Referring first to FIG. 1, the optical device 10 includes a light generating assembly 12, a fan 14, projection lens optics 16, and a filter 18. A light generating assembly 12 includes a base 20 and a cover 22 that define an internal volume into which the fan 14 circulates air for cooling purposes. Light emitted by the light generating assembly 12 passes through the projection lens optics 16 and the filter 18, wherein the generated light is modified and/or enhanced as desired. Light exiting the filter 18 can be directed into a color combiner of a projection lens system such as the system 300 shown in FIG. 7 and described in further detail below.

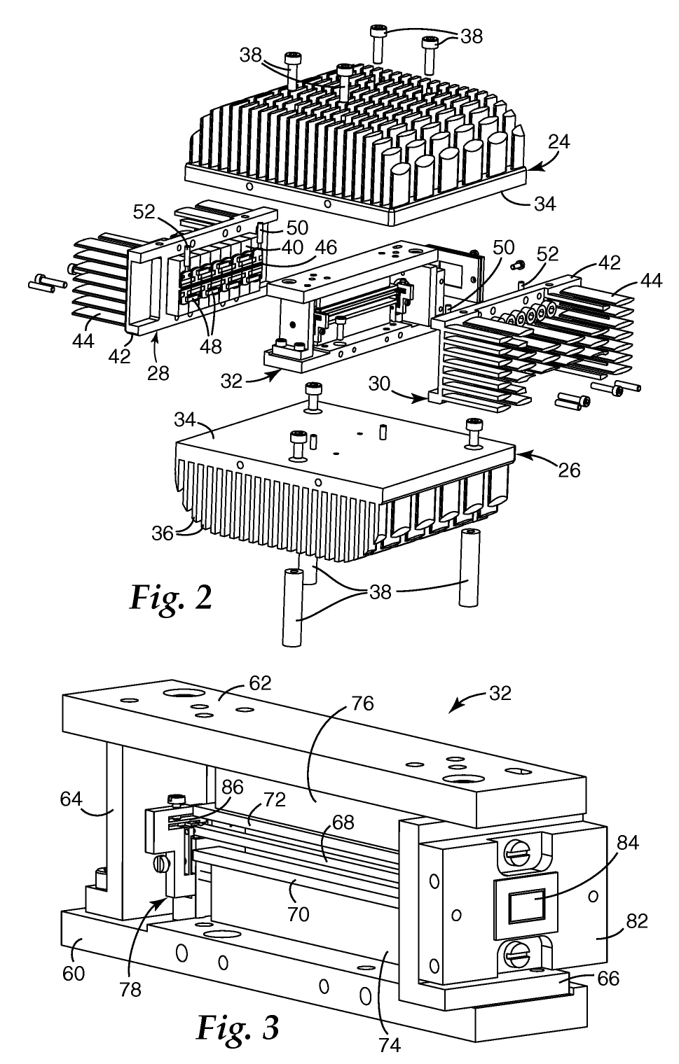

A light generating assembly 12 further includes, with reference to FIGS. 1 and 2, top and bottom housing members 24, 26, first and second LED housings 28, 30, and a prism assembly 32. The top and bottom housing members 24, 26 each include a mounting surface 34, heat sink fins 36, and a plurality of fasteners 38. The first and second LED housings 28, 30 each include an electronic substrate 40, a heat sink frame 42, heat sink fins 44, an array of LEDs 46, spacers 48, and electrical leads 50, 52. The heat sink frame 42 and heat sink fins 44 along with the heat sink fins 36 help to dissipate heat generated by the LEDs 46 and any energy absorbed from the LEDs and radiated by features of the prism assembly 32 exposed to the LEDs 46.

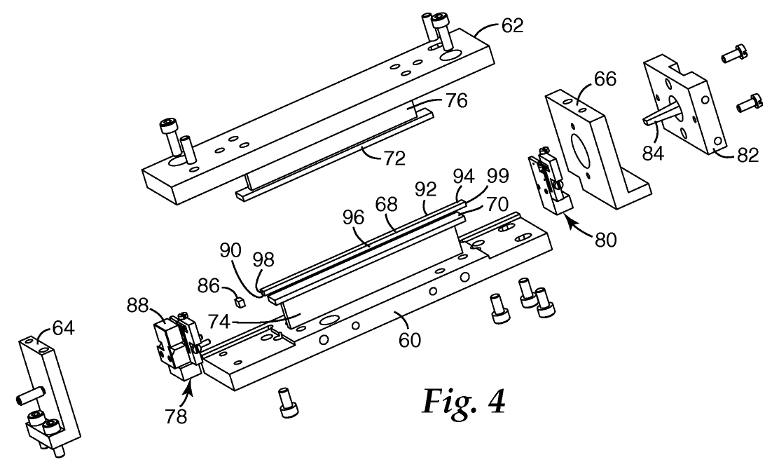

As shown in FIGS. 3 and 4, the prism assembly 32 includes lower and upper frame pieces 60, 62, first and second side frame pieces 64, 66, a prism 68, lower and upper reflectors 70, 72 positioned adjacent to prism 68, and lower and upper reflector support 74, 76 to which the lower and upper reflector 70, 72 are mounted. First and second prism mounts or frames 78, 80 retain the prism 68 in a desired position in the XY plane that is perpendicular to the longitudinal or Z axis of the prism 68. An extractor mount 82 holds an extractor 84 in alignment with one end of the prism 68. A mirror 86 is secured (e.g., using an adhesive) to the end of the prism 68. A silicone foam used as a spring 88 is adhered to a thin steel flexure component on an opposing end of the prism 68.

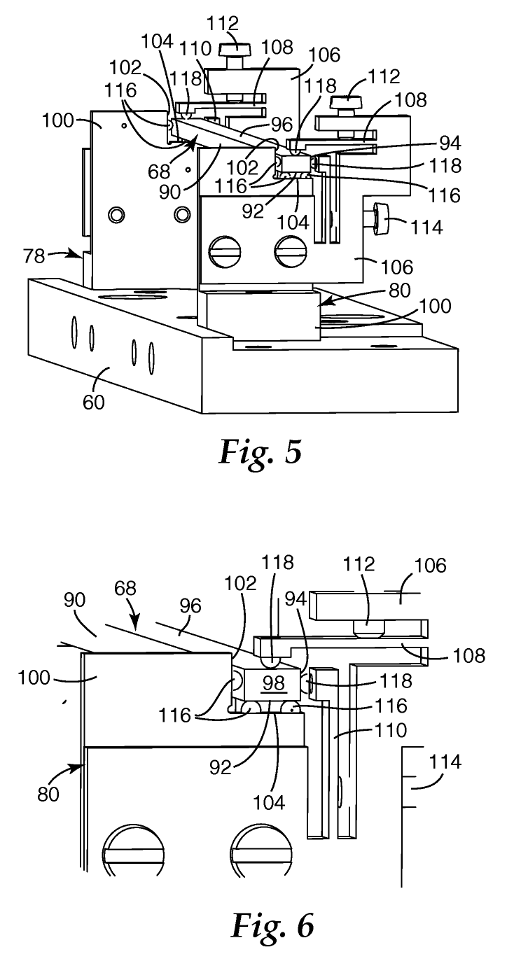

The prism assembly 32 is arranged to collect light from the LED arrays 46 and direct the collected light through the extractor 84 and out of the light generating assembly 12 and along a path into the projector lens optics 16. Light from the LEDs 46 enters in through first, second, third and fourth side surfaces 90, 92, 94, 96 of the prism (see FIG. 5). The mirror 86 is positioned at a first end surface 98 (see FIGS. 4 and 6) of the prism and the extractor 84 is positioned at a second end surface 99 of the prism (see FIG. 4). The side surfaces 90, 92, 94, 96 may exhibit total internal reflection (TIR) properties. The TIR properties of the prism 68 help to direct all collected light within the prism towards the second end surface 99 and the extractor 84.

The prism 68 may comprise a fluorescent material, wherein fluorescence is largely captured within the prism 68 by TIR. Example fluorescent materials for use in a optical element such as prism 68 is disclosed in co-owned and co-pending U.S. patent application Ser. No. 11/092284, entitled Fluorescent Volume Light Source, which is incorporated herein by reference.

The TIR properties of the prism 68 results from the difference in refractive index of the material of the prism (or coatings on the prism) relative to the refractive index of air surrounding prism 68. Typically, TIR properties are eliminated if an object having a similar refractive index to the prism index comes in contact with the prism. In order for the prism 68 to be supported relative to the reflectors 70, 72, the extractor 84, and the mirror 86 as well as the LEDs 46, the prism 68 must be contacted with a physical object that provides the support. In this configuration, the prism 68 preferably is not supported and positioned in space via contact of the end surfaces 98, 99 because those surfaces have specific purposes of either injecting light back into the prism via a mirror structure or another light source such as an LED (e.g., at first end 98) or being used to direct light out of the prism (e.g., directing light out of end surface 99 into extractor 84).

The first and second prism frame 78, 80 are configured with a plurality of contact supports that support the prism 68 in space in a way that minimizes reduction of the TIR properties of the prism 68. The first and second prism frame 78, 80 each include a base 100, having first and second mounting surfaces 102, 104, and an adjustable support 106 having first and second tension arms 108, 110 and first and second adjustment members 112, 114. The first and second mounting surfaces 102, 104 each include at least one fixed contact support 116. Each of the first and second tension arms 108, 110 each include at least one adjustable contact support 118 (see FIGS. 5 and 6). One of the first or second prism frames 78, 80 can include at least two fixed contact supports on at least one of the first and second mounting surfaces 102, 104 (see the two fixed contact supports 116 mounted on second mounting surface 104 of second frame 80 in FIG. 5) to establish a fixed XY position relative to the frames 78, 80. The use of two fixed contact supports on both of the mounting surfaces 102, 104 can generate alignment issues due to problems with aligning the fixed contact members in each of the X and Y planes.

The three point contact provided by the three fixed contact supports 116 shown in FIGS. 5 and 6 for the second frame member 80 establish an XY position for a cross-section of one end of the prism 68. In some embodiments, only a single fixed contact support is required along each of the first and second mounting surfaces 102, 104. Many variables can influence the number of fixed contact supports needed such as, for example, the structure of the fixed contact supports 116, the adjustable contact supports 118, and the prism 68, and the material composition of the prism. For example, if the fixed contact supports 116 provide a line contact with the prism 68 (e.g., a line contact provided by a longitudinal side of a cylindrical structure) the fixed contact supports would provide necessary fixation of the prism 68 in the XY plane via contact with the sides 90, 92 of the prism 68. In another example, one or more of the adjustable contact supports provides a line contact with the prism 68, which when combined with a line contact provided by one of the fixed contact supports would provide the necessary fixation of the prism in the XY plane. In this still further embodiment, at least one of the fixed contact supports or the adjustable contact supports is configured to engage at least two side surfaces of the prism thereby affixing the prism in the XY plane.

The first and second tension arms 108, 110 are configured as cantilever beam type structures having sufficient length to allow for flexing of the arm. Flexing of the tension arm results in movement of the adjustable contact support 118 supported at an end of the tension arm when a force is applied or released by the adjustment members 112, 114. The adjustment members 112, 114 are shown in FIGS. 5 and 6 as set screwed type structures. Rotation of the adjustment members 112, 114 relative to the adjustment support 106 can alter a biasing force applied by the adjustable contact supports 118 to sides 94, 96 of the prism 68. Many other types of tension structures may be used to provide the same or similar adjustable biasing force resulting from the configuration shown in FIGS. 5 and 6. Preferably, in all configurations the adjustable contact supports 118 are held in position with some type of biasing force that provides at least some automatic movement of the adjustable contact supports 118 relative to the fixed contact supports 116. For example, under conditions where the prism 68 expands and contracts due to temperature changes of the prism 68, the adjustable contact supports 118 can move in the X and Y direction to account for the expansion and contraction of the prism 68 while still applying a bias force that holds the prism 68 in the XY plane against the fixed contacts 116.

The adjustment support 106 can be replaced with an adjustment support having a different number or different configurations of tension arms, adjustment members, and adjustable contact supports. In one example, the prism supported by the first and second prism frames 78, 80 may have a different cross sectional shape than the generally rectangular cross section shown in FIGS. 5 and 6. For example, the prism may have a triangular cross section with three sides, or a cross section with five or more sides. In other embodiments, the prism can have a circular cross section. In still further embodiments, the prism has a multi-sided cross section wherein the sides have unequal lengths. The configuration of the first and second prism frames 78, 80 can be adjusted to accommodate different prism sizes and cross sectional configurations. For example, the first and second mounting surfaces 102, 104 of the base 100 may be arranged in a non-perpendicular arrangement and may support any number of fixed contact supports 116. Further, the adjustable support 106 may include any number of tensioning arms or other structure that provides adjustability of any number of adjustable contact supports used to retain the prism against the fixed contact supports.

Another example prism frame 278 is shown with reference to FIG. 7. Prism frame 278 includes a base 200 having a mounting surface 202, an adjustment support 206 that includes a tension arm 208, an adjustment member 212, and an adjustable contact support 218 mounted to the tension arm 208. A pair of fixed contact supports 216 is mounted to the mounting surface 202 and is arranged to hold the prism 268. Prism 268 includes first, second, third and fourth side surfaces 290, 292, 294, 296 and at least one end surface 298, four lateral edges (not labeled), and eight end edges (not labeled).

The fixed and adjustable contact supports 216, 218 may have any desired construction so as to provide fixation of the prism 268 in the XY plane. In one example, the adjustable contact support 218 includes a v-shaped structure having surfaces that contact side surfaces 292, 294. In other embodiments, the adjustable contact support 218 may include at least two structures having a convex surface such as an hemispherical surface that provide point contacts with one or two side surfaces of the prism 268. In still further embodiments, the adjustable contact support 218 is cylindrical structure that provides a line contact with the prism 268. The fixed contact supports 216 may be replaced with a single contact support that engages multiple side surfaces or at least one lateral edge of the prism 268. In still further embodiments, a fixed contact support may be mounted to a mounting surface 204 and configured to engage at least one side surface of the prism 268.

The contact supports 116, 118 are shown as generally spherical shaped structures. The point contact provided between the spherical surface and a side surface of the prism results in minimum light loss through the TIR surfaces of the prism. The spherical shaped structures could be replaced with hemispherical, cylindrical, or any other convex surface having a surface curvature that minimizes the contact area between the contact support and the prism side surfaces. A moderately curved convex surface may have advantages of minimized stress points as compared to a pointed structure that can create a high localized stress point. A spherical structure can also have advantages of ease of manufacturing particularly when using molding processes.

The size of the contact supports 116, 118 may vary depending on the size of the prism. In the configuration shown in FIGS. 1-6, the prism is about 2 inches (5.0 cm) long and has cross sectional dimensions of about 0.07 inches (0.18 cm) by about 0.04 inches (0.10 cm). A suitable size for the spherical contact supports when used with prisms in this range of sizes is about 0.02 inches (0.05 cm) to about 0.03 inches (0.08 cm) in diameter.

One suitable class of materials used for the prism includes inorganic crystals doped with rare-earth ions such as cerium-doped yttrium aluminum garnet (Ce:YAG) or doped with transition metal ions, such as chromium-doped sapphire or titanium-doped sapphire. Another suitable class of material includes a fluorescent dye doped into a polymer body. These types of materials are relatively rigid and relatively small. Rigidity of the material permits fixing of one end in the XY plane (see the three fixed contact supports shown in FIGS. 5 and 6 on the second prism frame 80), thereby fixing the XY position of one end cross-section of the prism. The prism can then be aligned in space by means of the prism frame at the other end of the prism. The size of the prism requires that the contact supports 116, 118 are relatively small. In one example, the contact supports have a diameter of about 0.025 inches (0.064 cm). In other types of optical systems, the prism is much larger (e.g., about 3 inches (7.6 cm) long with dimensions of about 0.5 by about 0.5 inches (1.3 cm)). In such a case, the contact supports can be significantly larger. When dealing with such small structures, it can be easier to manufacture a spherical object than to create a pointed object for a point contact. Likewise, it can be easier to manufacture a cylindrical object rather than a sharp edge (e.g., a razor blade edge) for providing a line contact that minimizes TIR loss.

Example Projection System

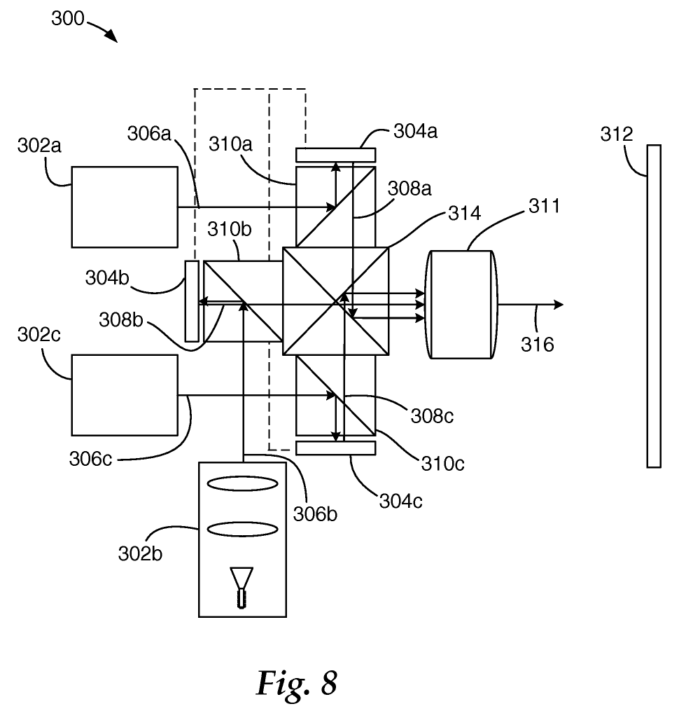

An exemplary embodiment of a projection system that might use the example optical devices disclosed above with reference to FIGS. 1-7 is schematically illustrated in FIG. 8. The projection system 300 is a 3-panel projection system, having light sources 302A, 302B, 302C that generate differently colored illumination light beams 306A, 306B, 306C, for example, red, green and blue light beams. In the illustrated embodiment, the green light source 302B, includes a prism assembly as part of a light generating assembly 301, wherein the prism assembly includes a prism supported by first and second prism frames having a number of fixed and adjustable contact supports as described in the examples above. However, any or all of the light sources 302A, 302B, 302C may include such prism assemblies used to direct illumination light beams toward their respective image-forming devices 304A, 304B, 304C.

The image forming devices 304A, 304B, 304C may be any kind of image-forming device. For example, the image-forming devices 304A, 304B, 304C may be transmissive or reflective image-forming devices. Liquid crystal display (LCD) panels, both transmissive and reflective, may be used as image-forming devices. One example of a suitable type of transmissive LCD image-forming panel is a high temperature polysilicon (HTPS) LCD. An example of a suitable type of reflective LCD panel is the liquid crystal on silicon (LCoS) panel. Another type of image-forming device, referred to as a digital multimirror device (DMD), uses an array of individually addressable mirrors, which either deflect the illumination light towards the projection lens or away from the projection lens. The light sources 302A, 302B, 302C may also include various elements such as polarizers, integrators, lenses, mirrors and the like for conditioning the illuminated light beams 306A, 306B, 306C.

The colored illumination light beams 306A, 306B, 306C are directed to their respective image forming devices 304A, 304B, 304C via respective polarizing beam splitters (PBSs) 310A, 310B, 310C. The image-forming devices 304A, 304B, 304C polarization modulate the incident illumination light beams 306A, 306B, 306C so that the respective, reflected, colored image light beams 308A, 308B, 308C are separated by the PBSs 310A, 310B, 310C and passed to a color combiner 314. The colored image light beams 308A, 308B, 308C may be combined into a single, full color image beam 316 that is projected by a protection lens unit 311 to the screen 312. In another embodiment (not illustrated) the illumination light may be transmitted through the PBSs to the image forming devices, while the image light is reflected by the PBSs.

Other embodiments of projection systems may use a different number of image-forming devices, either a greater or smaller number. Some embodiments and protection systems use a single image-forming device while other embodiments employ two image-forming devices. For example, projection systems using a single image-forming device are discussed in more detail in co-owned U.S. patent application Ser. No. 10/895,705 and projection systems using two image-forming devices are described in co-owned U.S. application Ser. No. 10/914,596, both of which are incorporated herein by reference. In a single panel projection system, the illumination light is incident on only a single image-forming panel. The incident light is modulated, so that the light of only one color is incident on a part of the image forming device at any one time. As time progresses, the color of the light incident on the image forming device changes, for example, from red to green to blue and back to red at which point the cycle repeats. This is often referred to as a “field sequential color” mode of operation. In other types of single panel projection systems, differently colored bands of light may be scrolled across the single panel, so that the panel is illuminated by the illumination system with more than one color at any one time, although any particular point on the panel is instantaneously illuminated with only a single color.

In a two-panel projection system, two colors are directed sequentially to a first image-forming device panel that sequentially displays an image for the two colors. The second panel is typically illuminated continuously by light of the third color. The image beams from the first and second panels are combined and projected. The viewer sees a full color image, due to integration in the eye.

The above specification, examples and data provide a complete description of the manufacture and use of the invention. Since many embodiments of the invention can be made without departing from the spirit and scope of the invention, the invention resides in the claims hereinafter appended.

What is claimed is:

1. An optical device, comprising:
an elongate optical element having total internal reflection properties along a length of the optical element;
first and second frame members positioned at opposing ends of the optical element; and
a plurality of contact supports mounted between the first and second support frames and the optical element, the contact supports each providing at most one of a point contact or a line contact with the optical element.

2. The optical device of claim 1, wherein the optical element has at least three side surfaces and opposing end surfaces, and at least one contact support engages each side surface at each of the opposing ends of the optical element.

3. The optical device of claim 1, wherein the contact supports include a contoured portion that defines the point contact with the optical element.

4. The optical device of claim 1, wherein at least one of the contact supports includes a hemispherical portion that defines the point contact with the optical element.

5. The optical device of claim 3, wherein at least one of the contact supports is fixed relative to the optical element, and at least one of the contact supports is adjustable relative to the optical element.

6. The optical device of claim 1, wherein at least three of the contact supports positioned between the first frame and adjacent first and second side surfaces of the optical element are fixed, and at least one of the contact supports positioned between the first frame and a remaining side surface of the optical element is adjustable.

7. The optical device of claim 1, wherein the optical element has a circular cross section and at least two of the contact supports positioned between the first frame and the optical element are fixed and at least one of the contact supports positioned between the first frame and the optical element is adjustable.

8. The optical device of claim 5, wherein the adjustable contact supports are coupled to a movable element that alters an amount of force applied by the adjustable contact supports to the optical element.

9. The optical device of claim 5, wherein the adjustable contact supports are each coupled to a separate adjustable member, each adjustable member configured to move relative to the optical element to alter a position of the adjustable contact support.

10. The optical device of claim 1, wherein at least one contact support engages a lateral edge of the elongate optical element.

11. An optical element mounting system for use in supporting an optical element in an optical device, the optical element having at least three side surfaces and opposing end surfaces, the mounting system comprising:
first and second frame members, wherein the optical element extends between and is supported by the frame members;
at least three fixed contact members mounted to the first frame member and at least two fixed contact members mounted to the second frame member, the fixed contact members arranged to each provide a point contact with first and second side surfaces of the optical element; and
at least one adjustable contact member in engagement with a third surface of the optical element, wherein a position of the adjustable contact members is adjustable relative to the optical element.

12. The mounting system of claim 11, wherein at least one of the contact members includes a hemispherical shaped portion that defines the point contact.

13. The mounting system of claim 12, wherein the adjustable contact members are mounted to adjustment arms that are movable relative to the optical element.

14. The mounting system of claim 11, wherein each of the first and second frame members comprises first and second adjustable contact members in engagement with respective third and fourth side surfaces of the optical element.

15. The mounting system of claim 11, wherein the optical element is a fluorescent rod having a rectangular cross section and total internal reflection properties along a length of the rod.

16. An illumination system capable of producing a beam of illumination light, the system comprising:
at least one light emitting diode (LED) configured to generate light;
an optical element receiving light from the at least one LED and including an extraction area and configured for internally reflecting at least some light traveling within the optical element and directing the light through the extraction area as the beam of illumination light;
a support structure arranged and configured to retain the optical element in an adjusted position, the support structure including at least one fixed engagement member in contact with each of a first sidewall and a second sidewall surfaces of the optical element and at least one adjustable engagement member in contact with a third sidewall of the optical element;
wherein the fixed and adjustable engagement members define a contact surface area with the optical element that minimizes a reduction of the internal reflection of light in the optical element.

17. The illumination system of claim 16, wherein at least one of the fixed and adjustable engagement members includes a spherical shaped portion that defines a point contact with the optical element.

18. The illumination system of claim 16, wherein the optical element includes at least four sidewall surfaces and two opposing end surfaces, one of the end surfaces defining the extraction area, the fixed engagement members contact adjacent sidewall surfaces and an adjustable engagement member contacts each of the remaining two sidewall surfaces.

19. The illumination system of claim 16, wherein each adjustable engagement member is defined by a leaf spring member having a contact surface formed near one end thereof, and an adjustment member engages the leaf spring to adjust a position of the contact surface relative to the optical element.
